(19) United States
(12) Patent Application Publication
(10) Pub. No.: US 2025/0369412 A1
(43) Pub. Date: Dec. 4, 2025

(54) Inline Water Treatment Turbine

(71) Applicant: Joseph A Bailly, Conrad, MT (US)

(72) Inventor: Joseph A Bailly, Conrad, MT (US)

(21) Appl. No.: 19/174,748

(22) Filed: Apr. 9, 2025

Related U.S. Application Data
(60) Provisional application No. 63/656,087, filed on Jun. 4, 2024.

(51) Int. Cl. F03B 13/00; F03B 11/02

(52) U.S. Cl. CPC F03B 13/00; F03B 11/02; F05B 2220/32

(57) ABSTRACT

An inline turbine having a rotor with vanes positioned in the fluid flow path and an array of rotor magnets, radially outwardly and effectively adjacent to the fluid flow path to magnetically condition the water of the fluid stream, where the array of rotor magnets rotate with the rotor, the rotor surrounded by a housing comprising a circumferential array of corresponding outer magnets proximate to the outer surface of the housing, and positionable to be magnetically attracted and repulsed by the rotor magnets so as to correspondingly rotate with the rotor, with a drive band circumferentially surrounding the housing immediately external to the array of outer magnets and rotating with the outer magnets. In this fashion, a fluid flow that imparts rotational motion on the rotor would rotate the array of inner magnets, which would cause the array of outer magnets to rotate, along with the drive band.

### CROSS-REFERENCE TO RELATED APPLICATIONS

This application claims the benefit of U.S. Application No. 63/656,087, filed on 4 Jun. 2024, by the present inventor, entitled “Inline Water Turbine,” which is hereby incorporated by reference in its entirety for all allowable purposes, including the incorporation and preservation of any and all rights to patentable subject matter of the inventor, such as features, elements, processes and process steps, improvements, and their descriptions that may supplement or relate to the subject matter described herein.

### BACKGROUND OF THE INVENTION

The present invitation relates to devices for generating energy from an inline water flow, which may include using a magnetic linkage between the turbine system and a generator, and may include magnetically conditioning the water as it flows through the turbine structure. Turbines driven by a fluid flow are widely used in the generation of energy. The magnetic conditioning of water, though not as well-known, is also widely studied and applied to various applications to effect changed water properties and efficacies.

Studies of earlier iterations of the present innovation have shown over the past several years that when applied to a quarter mile-long pivot irrigation system, the system may save enough water in one month to cover twenty football fields, one foot deep, (nearly thirteen million gallons). It may also reduce electrical needs to run the pivot system by 40 percent while increasing the quality and quantity of the chosen crop. With droughts potentially impacting much of the planet, a device according to the present disclosure may be important to mitigate irrigation water shortages and produce clean energy, using less fertilizer, which may reduce both economic and environmental impacts, while enabling higher-yielding crops, thereby addressing food shortages worldwide.

A Japanese patent application (JP2011230025A), published on 17 Nov. 2011, describes a “Device of Generating and Supplying Magnetized Water” where “permanent magnets 30 disposed opposite each other outside a pipe 24 and generating magnetized water by applying magnetized water treatment to the tap water flowing in the pipe 24; and a water turbine 18 including a rotatable rotary tube 34 [and] an electric power generator 42 generating power by the rotation of the rotary tube 34 of the water turbine 18 . . . ” That application teaches individual water treatment and power generation elements. In that disclosure a water flow passing through a magnetic field, within the effective zone of the magnets, and a turbine being turned by the water flow to generate water.

It would be an improvement to the field of turbine energy generation to provide a turbine system with a rotor, where the rotor has fins positioned in the fluid flow path, and the rotor has a drive band to transfer energy from the rotation of the rotor to an adjacent device, such as a generator, where the fins in the fluid flow path are positioned adjacent to magnets, within an effective zone of the magnets, to magnetically treat the water applying force to the fins. The rotor configuration may be sealed within a housing and transfer the rotational energy to an outer drive band with an array of rotor magnets, radially outwardly and effectively adjacent to the fluid flow path, where they may magnetically influence the water of the fluid stream to create magnetically treated water. The array of rotor magnets may rotate with the rotor, surrounded by a housing comprising a circumferential array of corresponding outer magnets proximate to the inner surface of the housing, and positionable to be magnetically influenced by the rotor magnets, with a drive band circumferentially surrounding the housing immediately external to the array of outer magnets. In this fashion, a fluid flow that imparts rotational motion on the rotor would rotate the array of inner rotor magnets, which would cause the array of outer magnets to rotate, along with the drive band. A generator may then be matched to functionally interface with the drive band to recapture electrical energy.

### BRIEF DESCRIPTION OF THE DRAWINGS

FIG. 1 is a perspective top view of an exemplary turbine system and generator according to the present invention.

FIG. 2 is a perspective side view of the exemplary turbine system and generator shown in FIG. 1.

FIG. 3 is a schematic side view of an exemplary turbine system according to the present invention.

FIG. 4 is a schematic cross-sectional side view of the exemplary turbine system of FIG. 3 cut at line A-A.

FIG. 5 is a cross-sectional side view of a housing junction detail.

FIG. 6 is a side view, perpendicular to the circumference plane, of an exemplary outer magnetic array and drive gear.

FIG. 7 is a normal side view, coplanar to the circumference plane, of an exemplary outer magnetic array and band gear.

FIG. 8 is a schematic view of the side of a segment of an exemplary rotor, showing an exemplary combination of a rotor magnet array and an outer magnet array.

FIG. 9 is a schematic illustration of a visualization of an exemplary fluid flow zone through an exemplary magnetic field.

FIG. 10 is a schematic illustration of an exemplary turbine system, coupled with a generator in a water treatment and energy recapture system.

FIG. 11 is a schematic illustration of an alternate drive linkage

### DESCRIPTION OF THE PREFERRED EMBODIMENT

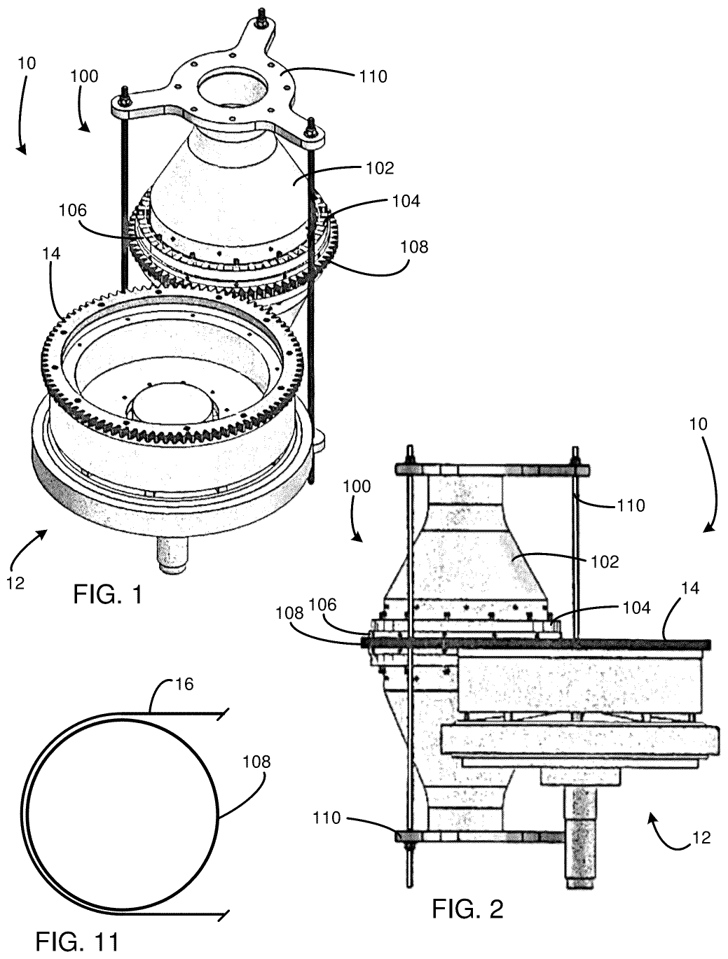

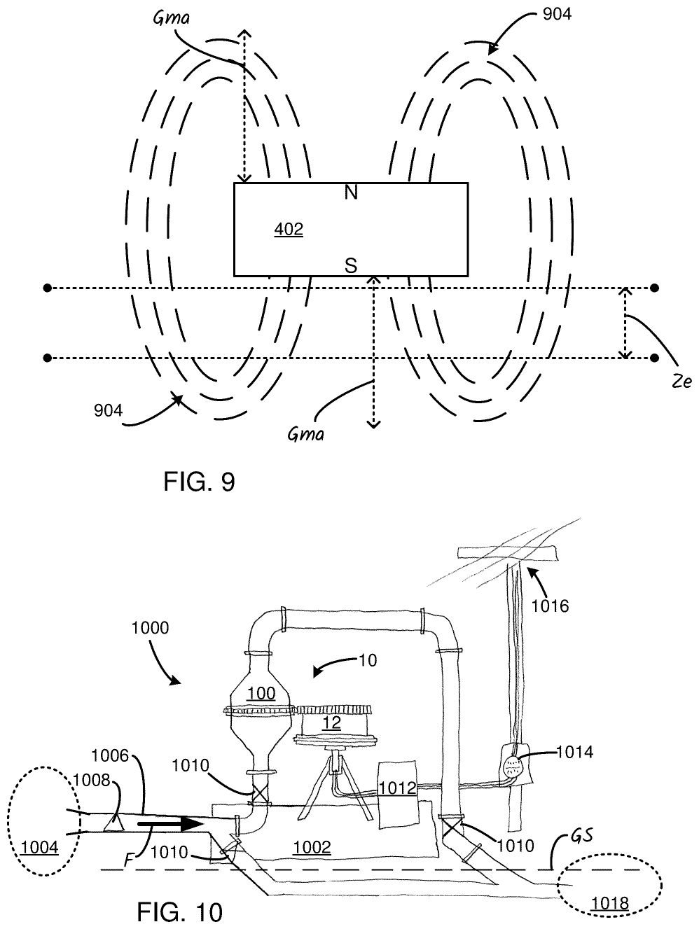

Referring now generally to FIGS. 1 and 9, an exemplary embodiment of the current innovation is shown, which may provide insight into the elements and their relationships in a claimed invention. Referring now primarily to FIGS. 1 and 2, in an exemplary embodiment turbine system 10 may have a turbine 100 and a generator 12. In an exemplary embodiment, turbine 100 may have a housing 102, which may include an inlet housing 112 and an exit housing 114. In an exemplary embodiment, a housing 102 may have an outer magnet array 104, an outer band 106, and a drive band 108 encircling the housing 102. An exemplary drive band 108 may protrude outwardly from the housing 102. In an exemplary embodiment, an outer magnet array 104 may be positioned and secured in an outer band 106, and a drive band 108 may be secured to the outer perimeter of the outer band 106, with the teeth of the drive band 108 oriented outwardly.

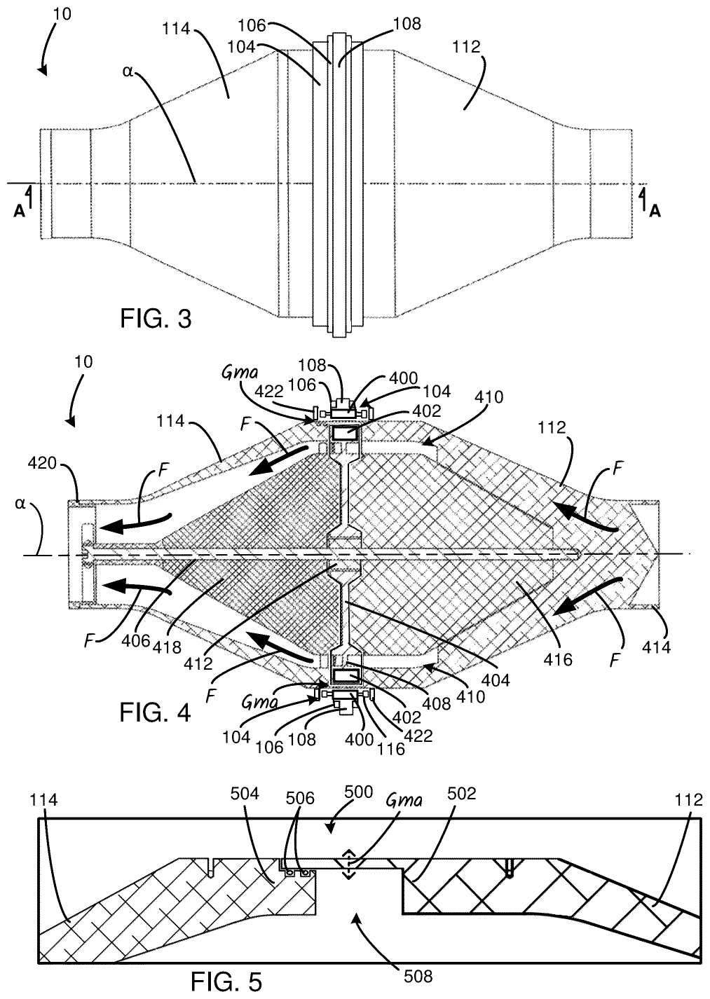

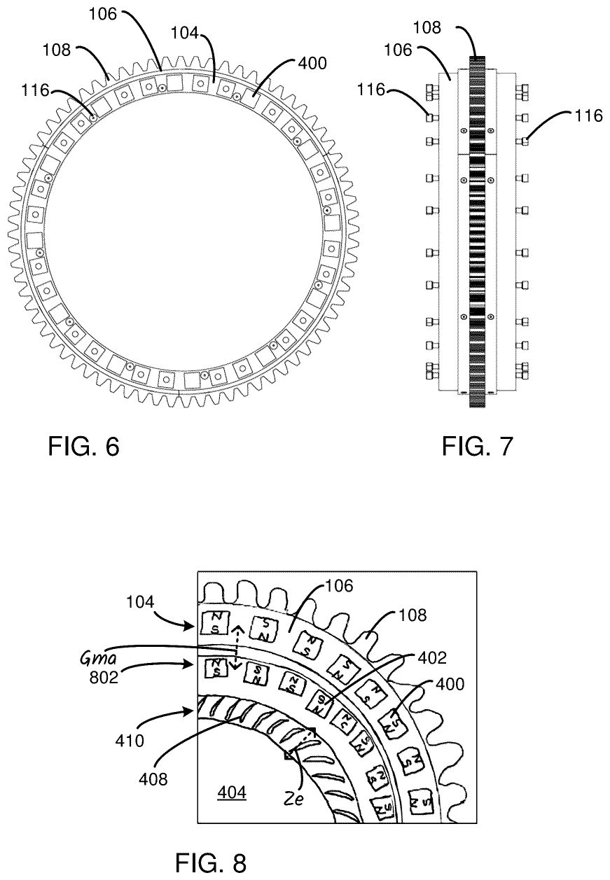

Referring now primarily to FIGS. 1 through 8, in an exemplary embodiment, the outer magnet array 104 may comprise a plurality of securely positioned outer magnets 400. In an exemplary embodiment, the outer magnets 400 may be removably secured within the outer magnet array 104. The exemplary drive band 108 may be configured to interface with an exemplary generator interface to transfer rotational energy from a turbine 100 to a generator 12. The drive band 108 and generator interface 14 may be a gear set, with the drive band 108 being a drive gear, and the generator interface 14 being a driven gear.

In an exemplary embodiment, a turbine system 10 may include a turbine 100 assembled on an assembly frame 110. A turbine 100 may comprise a housing 102. A housing 102 may include an inlet housing 112 and an exit housing 114, each of which may form about half of the housing 102. In an exemplary embodiment, each of an inlet housing 112 and an exit housing 114 may have the general form of a right circular cone, terminated prior to their apex. An inlet housing 112 and an exit housing 114 may be oriented with their widest symmetrical parts, referred to herein as bases, near and parallel to each other, and their apexes oriented in opposite directions. The exemplary housing is circumferentially oriented around axis α, which passes axially through the axis of each the inlet housing 112 and the exit housing 114 of housing 102. The interface of the inlet housing 112 and the exit housing 114 may include a housing junction 500.

Referring to FIG. 5, in an exemplary embodiment, a housing junction 500 may include a junction receiver 502 and a junction insert 504. The exemplary junction insert 504 may include a narrowed section to be inserted into a corresponding junction receiver 502. The narrowed section may include one or more seals seated into the junction receiver 504. The exemplary junction receiver 502 may have a portion that extends so that when joined with a corresponding junction insert 504 the portion would position outwardly of the narrowed section of the junction insert 504, and seal against the junction seals 506, creating a water-tight seal.

In an exemplary embodiment, the junction receiver 502 may have a recess into which a corresponding junction insert 504 may be positioned. Additionally, the recess of a junction receiver 502 may also form a rotor recess 508, into which a rotor 404 may extend. Such a rotor recess 508 would permit a rotor magnet array 802 on rotor 404 to be positioned in closer proximity to an outer magnet array 104 on the outside of the housing 102.

In an exemplary embodiment, an outer band 106, including an outer magnet array 104 and a drive band 108, may rotatably interface with the inlet housing 112 and the exit housing 114 and be secured to the housing 102 with a cam race 422. In an exemplary embodiment, the rotatable interface may include a series of roller pins 116 that may protrude from the outer band 106 and engage a surface of a cam race 422 on the inlet housing 112 and the exit housing 114. In an exemplary embodiment, the roller pins 116 may comprise a cam follower and a cam spacer. In an exemplary embodiment, a cam race 422 may keep the outer magnet array 104 positioned at the housing junction 500 and permit the outer band 106 to rotate freely with respect to the housing 102. In an exemplary embodiment, the attraction force between the rotor magnet array 802 and the outer magnet array 104 may keep a roller pin 116 of an outer band 106 firmly engaged against a cam race 422 of both the inlet housing 112 and the exit housing 114.

In an exemplary embodiment, the turbine system 10 may also have a generator 12 that is appropriately sized to function with the turbine 100. In an exemplary embodiment, the generator 12 may have a generator interface 14 designed and configured to complement the turbine 100. In an exemplary embodiment, the generator interface 14 may comprise a series of teeth that complement the teeth of the drive band 108 to facilitate the transfer of rotational motion in a turbine 100 into rotational motion in a generator 12. In an alternate embodiment, the generator interface 14 may comprise a friction surface that complements the surface of the drive band 108 to facilitate the transfer of rotational motion. In an additional alternate exemplary embodiment, the drive band 108 may transfer rotational motion to the generator interface 14 through a continuous belt 16 or chain connection, as shown in FIG. 11. It is understood that the drive band 108 may transfer rotational motion and energy to an adjacent device other than a generator 12 described in the exemplary embodiment.

Referring now primarily to FIGS. 4 through 8, the inner configuration of an exemplary turbine 100 may be explored, and, in so doing, better appreciate the potential of a variety of claimed inventions. In an exemplary embodiment, a turbine 100 may have a generally centrally positioned rotor 404 rotatably fixed perpendicular to a central axle 406. The axle 406 has a rotational axis α through its length. In an exemplary embodiment, a rotor 404 may rotate within the housing 102 of the turbine 100 about a longitudinal axis α.

In an exemplary embodiment, a fluid in a fluid flow path F may enter the housing 102 through an entrance shroud 414, and be directed toward the rotor 404 positioned generally perpendicular to the fluid flow path F. After entering the entrance shroud 414, the fluid flow path F may encounter an inlet stator 416. In an exemplary embodiment, an inlet stator 416 may be attached to the central axle 406, and function to radially disperse the fluid flow path F to the perimeter of the housing 102, through a fluid flow channel 410. A fluid flow channel 410 may be formed by the inner surface of the inlet housing 112 and the outer surface of the inlet stator 416. The fluid flow channel 410 directs that fluid flow path F to the outer perimeter area of rotor 404.

In an exemplary embodiment, the rotor 404 may have an array of fins or vanes 408 dispersed around the outer area of the rotor 404. In an exemplary embodiment, a rotor magnet array 802 may be positioned around the perimeter of the rotor 404, immediately outside the vanes 408. In an exemplary embodiment, a rotor magnet array 802 may be comprised of a plurality of rotor magnets 402. In an exemplary embodiment, the rotor magnets 402 may be removably secured within the rotor magnet array 802. In an exemplary embodiment, the fluid flow channel 410 directs the fluid flow path F into the vanes 408, after which the fluid flow path F flows between the exit stator 418 and the exit housing 114 to exit the housing 102 through exit shroud 420. The fluid flow force of the fluid in fluid flow path F imparts rotational motion to the rotor 404 through the interface with the vanes 408.

Referring now primarily to FIGS. 4 through 9, in an exemplary embodiment, the configuration of the rotor 404 and the outer band 106 enable the rotation of a rotor 404 to impart rotational motion and force to the outer band 106. In an exemplary embodiment, the transmission of rotation from the rotor 404 to the outer band 106 may be accomplished through rotor magnet array 802 and a complementary outer magnet array 104.

In an exemplary embodiment, a rotor magnet array 802 may be comprised of a series of rotor magnets 402 arranged in the rotor 404 with their poles oriented radially from axis α. In an exemplary embodiment, an even number of rotor magnets 402 may be arranged. The north and south poles of each rotor magnet 402 are oriented radially from axis α, and alternate orientation such that a rotor magnet 402 with a north pole oriented outwardly will only be adjacent to rotor magnets 402 with south poles oriented outwardly, and a rotor magnet 402 with a south pole oriented outwardly will only be adjacent to rotor magnets 402 with north poles oriented outwardly.

In an exemplary embodiment, similarly, an outer magnet array 104 may be comprised of a series of outer magnets 400 arranged with their poles oriented radially from axis α within outer band 106. In an exemplary embodiment, an even number of outer magnets 400 may be arranged. The north and south poles of each outer magnet 400 are oriented radially from axis α, and alternate orientation such that an outer magnet 400 with a north pole oriented outwardly will only be adjacent to outer magnets 400 with south poles oriented outwardly, and an outer magnet 400 with a south pole oriented outwardly will only be adjacent to outer magnets 400 with north poles oriented outwardly.

In an exemplary embodiment, in a complementary turbine 100 and generator 12, the number of outer magnets 400 in the outer magnet array 104 may equal the number of rotor magnets 402 in the rotor magnet array 802. In an exemplary embodiment where the outer magnet array 104 and the rotor magnet array 802 contain the same number of outer magnets 400 and rotor magnets 402, respectively, the south pole of each outer magnet 400 may align with a north pole of a rotor magnet 402. So configured, the attraction bond between the outer magnet array 104 and the rotor magnet array 802 may be maximized.

In an exemplary embodiment, an exemplary magnetic field 904 of an exemplary rotor magnet 402 is illustrated in FIG. 9. It should be understood that each rotor magnet 402 and each outer magnet 400 may have a similar exemplary magnetic field 904. It should also be understood that the magnetic field 904 may impact elements proximate to the outer magnet array 104 and the rotor magnet array 802.

It should be understood that magnetic attraction force and magnetic repulsion force are effective across a distance. The attraction force is stronger when a north and south pole are closer together, and the repulsion force is stronger when two similar poles are closer together. In an exemplary embodiment, the distance across which magnetic attraction may be effective may be referred to herein as a magnetic attraction gap Gma. In an exemplary embodiment, the magnetic attraction gap Gma may be found between every pair of north or south poles of a rotor magnet 402 and the north or south pole of the respective adjacent outer magnet 400. In an exemplary embodiment, it may then be said that the magnetic attraction gap Gma is a distance between the rotor magnet array 802 and the outer magnet array 104 over which the magnetic attraction force is still effective between the respective rotor magnets 402 and outer magnets 400. Though the magnetic attraction gap Gma is shown from the north pole in FIG. 9, it is understood that a south pole would have a similar magnetic attraction gap Gma, as seen in FIG. 8.

It should be understood that a magnetic field is effective at magnetically influencing materials across a distance. In an exemplary embodiment, the range of distances in which a magnetic field is effective at magnetically influencing a fluid flow path F is referred to herein as an effective zone Ze. In an exemplary embodiment, the fluid flow channel 410 may be positioned to be within the effective zone Ze, such that fluid flow path F material within the fluid flow channel 410 may experience exposure to the effective zone Ze, and would experience exposure to the magnetic field and magnetic influence. Water that experiences exposure to the magnetic field and magnetic influence may be considered magnetically treated or magnetically conditioned. Water that experiences exposure within the effective zone Ze for a desired duration may be considered effectively treated water. Treated water may also be referred to herein as conditioned water. Though the effective zone Ze is shown from the south pole in FIG. 9, it is understood that a north pole would have a similar effective zone Ze, as seen in FIG. 8.

In an exemplary embodiment, a fluid flowing in the fluid flow path F that passes through the flow channel 410 and interfaces with the vanes 408, the intersection of which is herein referred to as the vane zone, will experience exposure within the effective zone Ze and may be magnetically treated.

The type of magnets that are suitable in at least some embodiments include N50 rare earth. Such magnets are available from various suppliers, which may include K&J Magnetics, Inc., in Pipersville, PA (www.kjmagnetics.com). Exemplary spacing, also referred to herein as the effective magnetic attraction gap Gma, between the outer magnet array 104 and the rotor magnet array 802, can be a minimal distance, and can reach a distance of about 1.25 inches. In an exemplary embodiment, the inlet housing 112 and the exit housing 114 overlap in the effective magnetic attraction gap Gma, with each layer of the housing having a thickness of about one-sixteenth of an inch, making the housing one-eighth of an inch thick.

In an exemplary embodiment, the effective magnetic attraction gap Gma could be minimally more than one-eighth of an inch, and up to about 1.25 inches. In an exemplary embodiment, the effective magnetic attraction gap Gma may be between about 0.25 of an inch and one inch, and may be about 0.625 inches. The outer magnet array 104 and the rotor magnet array 802 stay aligned through both attraction forces between the pairs of north and south poles, and repelling forces of the adjacent same pole magnet. An estimation of the total force that maintains alignment of the rotor magnet array 802 with the outer magnet array 104 is a summation of these forces. For a pair of arrays comprised of a combination of 4″ outer magnets 400 and 2″ rotor magnets 402, the total of the attraction and repelling forces may be calculated to be about 4,870 lbs. This is the force between the rotor magnet array 802 and the outer magnet array 104 that may result in a rotational force directed from the drive band 108 to the generator interface 14 to generate electricity.

In an exemplary embodiment, the fluid flow path F is directed into the effective zone Ze of the rotor magnet array 802. In an exemplary embodiment, the effective zone Ze may be the area that ranges from about 0.047 inches to 1.078 inches from the rotor magnet array 802. Studies have shown that water exposed to such an effective zone Ze may treat the water with a magnetic field strength of at least 500 gauss. Effective ranges for water treatment has been noted in the range of about 5,371 gauss at the closest distance, to about 870 gauss at a greater distance, and as low as 500 gauss at the farthest distance from the magnets. The strength of the magnets in the rotor magnet array 802 and the outer magnet array 104, and the size of the fluid flow channel 410 determines the size, shape, and strength of the effective zone Ze. The shapes of the rotor 404, the housing 102, the entrance stator 416, and the exit stator 418 affect the positioning of the effective zone Ze. The combination of variables, which include the strength of the magnets in the rotor magnet array 802 and the outer magnet array 104, the size of the fluid flow channel 410, and the speed of the fluid flow path F, may be chosen in order to achieve the desired exposure to the particular magnetic field, with its particular size, shape, and strength, and thereby to achieve a desired level of effective water treatment.

In an exemplary embodiment of a turbine system 10 where the variables have been chosen to achieve effective water treatment, given the combination of variables, a fluid flow path F that passes through the flow channel 410 and interfaces with the vanes 408 will experience exposure within the effective zone Ze, and the contents of the fluid flow path F will become effectively treated water.

Referring now primarily to FIG. 10, an exemplary embodiment of a water conditioning and power scavenger system 1000 is shown. In an exemplary embodiment, a turbine 100 is paired with a suitable generator 12 to form a turbine system 10. A fluid flow path F is created by drawing water from a water source 1004. A pipe system operatively links a water source 1004 with the turbine system 10, with a pump 1008 to produce the flow force. It is appreciated that the position of the water source 1004 may influence the flow force in the fluid flow path F. A water source 1004 positioned above a turbine system 10 would have the force of the hydraulic head of the water that may be able to replace a pump 1008 and create the fluid flow path F.

Various valves may control the routing of the fluid flow path F within the pipe system 1006, allowing for the selective routing of the fluid flow path F through turbine 100. Water flowing through turbine 100 is magnetically conditioned and may be routed to a water use site 1018. Examples of water use sites 1018 may include, without limitation, an irrigation system, a greenhouse or grow operation, an apartment facility, and a residential water supply system.

It is understood that portions of the piping system 1006 may be disposed under the ground surface GS. In an exemplary embodiment, a pad 1002, possibly comprised of reinforced concrete, may provide a foundation for the turbine system 10.

Electrical energy from the generator 12 may be routed through an electrical current inverter 1012 to convert the DC current generated by the generator 12 into AC current suitable for introduction to the electrical grid, or back into the electrical supply to the pump 1008 to reduce total electrical usage. In an exemplary embodiment, an electrical meter 1014 is provided to measure the quantity of current sent to the electrical transmission lines 1016, which comprise a distribution portion of the electrical grid.

In an exemplary embodiment, water within the fluid flow path F that experiences the turbine 100, may be considered effectively treated water, and may be routed within the pipe system 1006 for use. Appropriate uses may include agricultural irrigation, where crops may benefit from the effectively treated water.

The foregoing disclosure and description of the invention are illustrative and explanatory thereof. The examples contained in this specification are merely possible implementations of the current device, and alternatives to the particular features and elements may be changed without departing from the spirit of the invention. The present invention should only be limited by the following claims and their legal equivalents since the provided exemplary embodiments are only examples of how the invention may be employed and are not exhaustive.

What is claimed is:

1. An inline water turbine, adaptable to a system that supports a fluid flow, comprising:
a housing, which establishes a fluid flow path for the fluid flow;
a rotor having a set of vanes;
the rotor positioned within the housing;
a drive band positioned outside the housing and outward of the rotor;
the set of vanes positioned to intersect the fluid flow path such that a fluid flow within the fluid flow path imparts rotation in the rotor and the drive band;
the drive band configured to transfer energy to an adjacent device; and
a plurality of magnets positioned adjacent to the fluid flow path to create an effective zone for water treatment at the intersection of the set of vanes and the fluid flow path.

2. The inline water turbine of claim 1, further comprising:
the plurality of magnets magnetically linking the rotor and the drive band for synchronous rotation.

3. The inline water turbine of claim 1, further comprising:
the rotor having an axis;
the plurality of magnets including a rotor magnet array;
the rotor magnet array distal the axis; and
the set of vanes intermediate the axis and the rotor magnet array.

4. The inline water turbine of claim 1, further comprising:
the plurality of magnets including an outer magnet array intermediate the housing and the drive band; and
the outer magnet array and the drive band rotatably securable to the housing for synchronous rotation.

5. The inline water turbine of claim 1, further comprising:
the rotor having an axis;
the plurality of magnets including a rotor magnet array;
the rotor magnet array distal the axis;
the set of vanes intermediate the axis and the rotor magnet array;
the plurality of magnets including an outer magnet array intermediate the drive band;
the outer magnet array and the drive band rotatably securable to the housing for synchronous rotation; and
the rotor magnet array and the outer magnet array each having an even number of magnets arranged with the poles of each magnet oriented radially outward from the axle axis, the north and south poles alternated such that a magnet with a north pole oriented outwardly is adjacent to magnets with south poles oriented outwardly.

6. The inline water turbine of claim 5 wherein the magnets of the rotor magnet array and the outer magnet array are rare earth magnets.

7. The inline water turbine of claim 5 wherein the magnets of the rotor magnet array possess a field strength of 500 gauss or more in the effective zone.

8. The inline water turbine of claim 5 wherein the magnets of the rotor magnet array and the outer magnet array are separated by a magnetic attraction gap of less than 1.25 inches.

9. An inline water turbine, comprising:
a housing having an inlet housing and an exit housing, the inlet housing and an exit housing each having a generally right circular cone shape, the shape having a base, and an apex;
the inlet housing having an entrance and an interior surface;
a generally circular rotor having an axis perpendicular to its radius and a set of vanes distal the axis;
an entrance stator having a generally right circular cone-shaped exterior surface;
an axle;
the inlet housing, entrance stator, rotor, and each mountable on the axle;
the entrance stator exterior surface forming a fluid flow path from the inlet housing entrance to the rotor vanes; and
a plurality of magnets positioned adjacent to the fluid flow path to create an effective zone for water treatment at the intersection of the set of vanes and the fluid flow path.

10. The inline water turbine of claim 9, further comprising:
the plurality of magnets magnetically linking the rotor and the drive band for synchronous rotation.

11. The inline water turbine of claim 9, further comprising:
the plurality of magnets including a rotor magnet array; and
the set of vanes intermediate the axis and the rotor magnet array.

12. The inline water turbine of claim 9, further comprising:
the plurality of magnets including an outer magnet array intermediate the housing and the drive band; and
the outer magnet array and the drive band rotatably securable to the housing for synchronous rotation.

13. The inline water turbine of claim 9, further comprising:
the plurality of magnets including a rotor magnet array;
the set of vanes intermediate the axis and the rotor magnet array;
the plurality of magnets including an outer magnet array intermediate the drive band;
the outer magnet array and the drive band rotatably securable to the housing for synchronous rotation; and
the rotor magnet array and the outer magnet array each having an even number of magnets arranged with the poles of each magnet oriented radially outward from the axle axis, the north and south poles alternated such that a magnet with a north pole oriented outwardly is adjacent to magnets with south poles oriented outwardly.

14. The inline water turbine of claim 13 wherein the magnets of the rotor magnet array and the outer magnet array are rare earth magnets.

15. The inline water turbine of claim 13 wherein the magnets of the rotor magnet array possess a field strength of 500 gauss or more in the effective zone.

16. The inline water turbine of claim 13 wherein the magnets of the rotor magnet array and the outer magnet array are separated by a magnetic attraction gap of less than 1.25 inches.

17. An inline water turbine, comprising:
a housing having an inlet housing and an exit housing, the inlet housing having a generally right circular conical shaped interior surface;
the inlet housing having a base, an apex, and a housing axis of symmetry corresponding to the base, apex, and axis of symmetry of the conically shaped interior surface;
the inlet housing having a fluid entrance at the apex;
a generally circular rotor having an axis perpendicular to its radius, a rotor magnet array distal the axis, and a set of vanes intermediate the axis and the rotor magnet array;
an entrance stator having a generally right circular conically shaped exterior surface, the entrance stator having a stator base corresponding to the base of the conically shaped exterior surface;
an axle having a rotational axis;
the entrance stator mounted on the axle with the rotational axis aligned along the stator axis of symmetry;
the inlet housing mounted to the axle with the rotational axis aligned along the inlet housing axis of symmetry and radially surrounding the entrance stator;
the rotor rotationally mounted to the axle with the rotational axis aligned with the rotor axis and proximate to the bases of the entrance stator and inlet housing;
the inlet housing exterior surface and the entrance stator exterior surface forming a fluid flow path from the inlet housing entrance to the rotor vanes, the intersection of the fluid flow path and the rotor vanes forming a vane zone;
an outer band having an outer magnet array and a drive band rotatably mounted intermediate to the bases of the inlet housing and the exit housing;
the rotor magnet array and the outer magnet array each having an even number of magnets arranged with the poles of each magnet are oriented radially outward from the axle axis, the north and south poles alternated such that a magnet with a north pole oriented outwardly is adjacent to magnets with south poles oriented outwardly;
the outer magnet array within the magnetic attraction zone of the rotor magnet array;
and a magnet in the rotor magnet array having a magnetism-effective zone that extends across the vane zone.

18. The inline water turbine of claim 17 wherein the magnets of the rotor magnet array and the outer magnet array are rare earth magnets.

19. The inline water turbine of claim 17 wherein the magnets of the rotor magnet array possess a field strength of 500 gauss or more in the effective zone.

20. The inline water turbine of claim 17 wherein the magnets of the rotor magnet array and the outer magnet array are separated by a magnetic attraction gap of less than 1.25 inches.
